(19) United States
(12) Patent Application Publication
(10) Pub. No.: US 2015/0183029 A1
(43) Pub. Date: Jul. 2, 2015

(54) Multi-Insert Tool Clamp, Tool Holder Assembly And Cutting Tool

(71) Applicant: Iscar, Ltd, Tefen (IL)

(72) Inventors: Dima Makhlin, Nesher (IL); Sergey Chistyakov, Nahariya (IL)

(73) Assignee: Iscar, Ltd., Tefen (IL)

(21) Appl. No.: 14/144,167

(22) Filed: Dec. 30, 2013

(51) Int. Cl. B23B 27/04

(52) U.S. Cl. CPC B23B 27/04; B23B 2205/00; B23B 2210/02; B23B 2260/03

(57) ABSTRACT

A cutting tool having a tool holder assembly for removably securing a plurality of cutting inserts. The tool holder assembly includes a tool holder body with an insert receiving pocket formed in a front end portion thereof, and a multi-insert tool clamp connected to the tool holder body. The clamp has a tool holder connecting portion and an insert clamping portion spaced apart therefrom, the insert clamping portion including a clamping protrusion and a plurality of clamping fingers. A clamping passage separates the plurality of clamping fingers from the clamping protrusion. At least one clamping slot separates the plurality of clamping fingers, and a slot plane longitudinally bisects each clamping slot. The clamping protrusion laterally extends along a clamping axis transverse to the at least one slot plane, and the at least one slot plane intersects the clamping protrusion.

### FIELD OF THE INVENTION

The present invention relates to a tool holder assembly for removably securing a plurality of cutting inserts and a single multi-insert clamp therefor, for use in metal cutting processes in general, and for parting and cut-off operations in particular.

### BACKGROUND OF THE INVENTION

Within the field of tool holder assemblies for removably securing a plurality cutting inserts, devices are known having one or several insert receiving pockets, and devices having one insert receiving pocket are known having one or several clamping members.

U.S. Pat. No. 3,829,943 discloses a threading tool having a plurality of closely spaced cutting inserts to be held in a recess, a clamping arrangement for exerting individual pressure on each of said inserts comprising a set of digital clamps comprising a first member having at least one projecting finger, a second member having a plurality of projecting fingers, said members being in overlying orientation with said fingers in interdigital relation extending in one direction and defining a top clamp member and a bottom clamp member.

U.S. Pat. No. 6,612,207 discloses a turning assembly for turning a workpiece includes a holder and plurality of turning bits mounted next to one another in a parallel relationship for simultaneously engaging the workpiece. The turning bits are mounted in respective holding elements which are individually adjustably mounted in the holder. Spacers can be provided to space the turning bits apart. Safety devices are provided, each including an elastic element for frictionally retaining a respective turning bit and/or spacer within the holder to enable the holder to be manipulated without the turning bits and/or spacers falling out.

US 2011/0293382 A1 discloses a multi-grooving tool holder for holding cutting members seated in a side-by-side formation in a clamping portion of the holder. The clamping portion includes an upper clamp and a lower clamp and an elastic member is located in one of the upper and lower clamps. When cutting members are assembled in the clamping portion, the elastic member engages the cutting members and aligns each cutting member independently, by applying a force, and consequently a moment on the cutting members.

### SUMMARY OF THE INVENTION

In accordance with the present invention, there is provided a multi-insert tool clamp for removably securing a plurality of cutting inserts in a tool holder body, the clamp comprising a tool holder connecting portion and an insert clamping portion spaced apart therefrom,

the insert clamping portion including a clamping protrusion and a plurality of clamping fingers,
a clamping passage separates the plurality of clamping fingers from the clamping protrusion,
at least one clamping slot separates the plurality of clamping fingers, and
a slot plane longitudinally bisects each clamping slot,

wherein:

the clamping protrusion laterally extends along a clamping axis transverse to the at least one slot plane, and the at least one slot plane intersects the clamping protrusion.

Also in accordance with the present invention, there is provided a tool holder assembly for removably securing a plurality of cutting inserts, comprising a tool holder body with a single insert receiving pocket formed in a front end portion thereof, and the aforementioned clamp connected to the tool holder body.

Further in accordance with the present invention, there is provided a cutting tool comprising the aforementioned tool holder assembly, and a plurality of cutting inserts removably secured in the single insert receiving pocket.

### BRIEF DESCRIPTION OF THE DRAWINGS

For a better understanding, the invention will now be described, by way of example only, with reference to the accompanying drawings in which chain-dash lines represent cut-off boundaries for partial views of a member and in which:

FIG. 1 is an exploded perspective view of a tool holder assembly in accordance with some embodiments of the present invention;

FIG. 2 is a front end view of the tool holder assembly shown in FIG. 1;

FIG. 3 is a side view of the tool holder assembly shown in FIG. 1;

FIG. 4 is a bottom view of a multi-insert tool clamp in accordance with some embodiments of the present invention;

FIG. 5 is a cross-sectional view of the clamp shown in FIG. 4 taken along the line V-V;

FIG. 6 is a perspective view of a cutting tool in accordance with some embodiments of the present invention;

FIG. 7 is a side view of the cutting tool shown in FIG. 6, including a local cross-section VIII taken along a slot plane; and

FIG. 8 is a detailed view of the cutting tool shown in FIG. 7 at the local cross-section VIII.

### DETAILED DESCRIPTION OF THE INVENTION

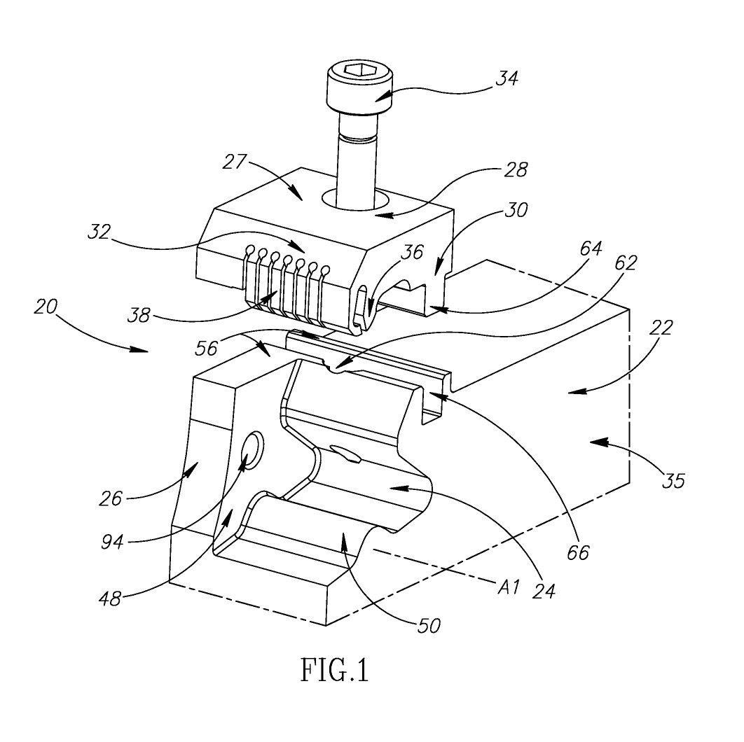

Attention is first drawn to FIGS. 1 to 3, showing a tool holder assembly 20 including a tool holder body 22 with a single insert receiving pocket 24 formed in a front end portion 26 thereof, and a single multi-insert tool clamp 28 connected to the tool holder body 22.

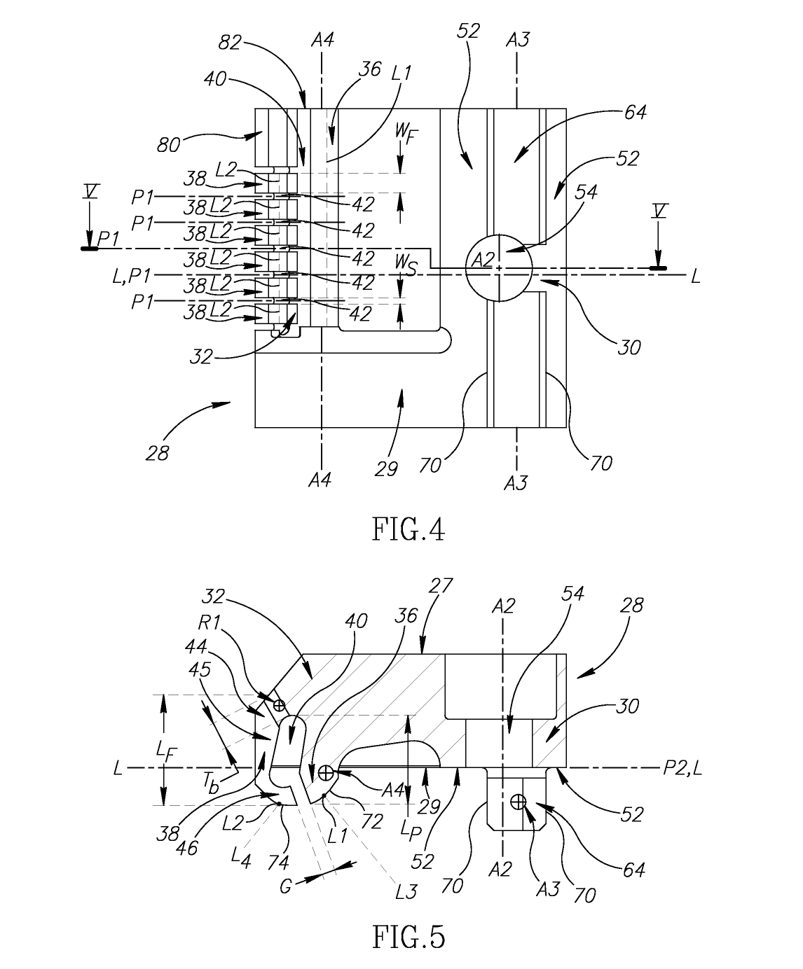

According to the present invention, as shown in FIGS. 4 and 5, the clamp 28 includes opposing top and bottom surfaces 27, 29, a tool holder connecting portion 30, and an insert clamping portion 32 spaced apart from the tool holder connecting portion 30.

In some embodiments of the present invention, the clamp 28 may have unitary one-piece construction.

As shown in FIG. 1, the connecting portion 30 may be removably fastened to the tool holder body 22 adjacent the insert receiving pocket 24 by means of a fastening member 34.

In other embodiments of the present invention (not shown), the connecting portion 30 may be integrally attached to the tool holder body 22.

As shown in FIG. 3, the tool holder body 22 may have a shank portion 35 extending rearwardly from the front end portion 26, and the connecting portion 30 of the clamp 28 may be at least partially located rearward of the insert receiving pocket 24.

It should be appreciated that throughout the description and claims, use of the term “rearward” refers to a relative position in FIG. 3, to the right of the insert receiving pocket 24.

According to the present invention, the insert clamping portion 32 includes a clamping protrusion 36 and a plurality of clamping fingers 38.

In some embodiments of the present invention, the plurality of clamping fingers 38 may be identical to each other.

Also, in some embodiments of the present invention, the clamping protrusion 36 may be located between the connecting portion 30 and the plurality of clamping fingers 38.

According to some embodiments of the present invention, as shown in FIGS. 3 and 4, a clamping passage 40 separates the plurality of clamping fingers 38 from the clamping protrusion 36.

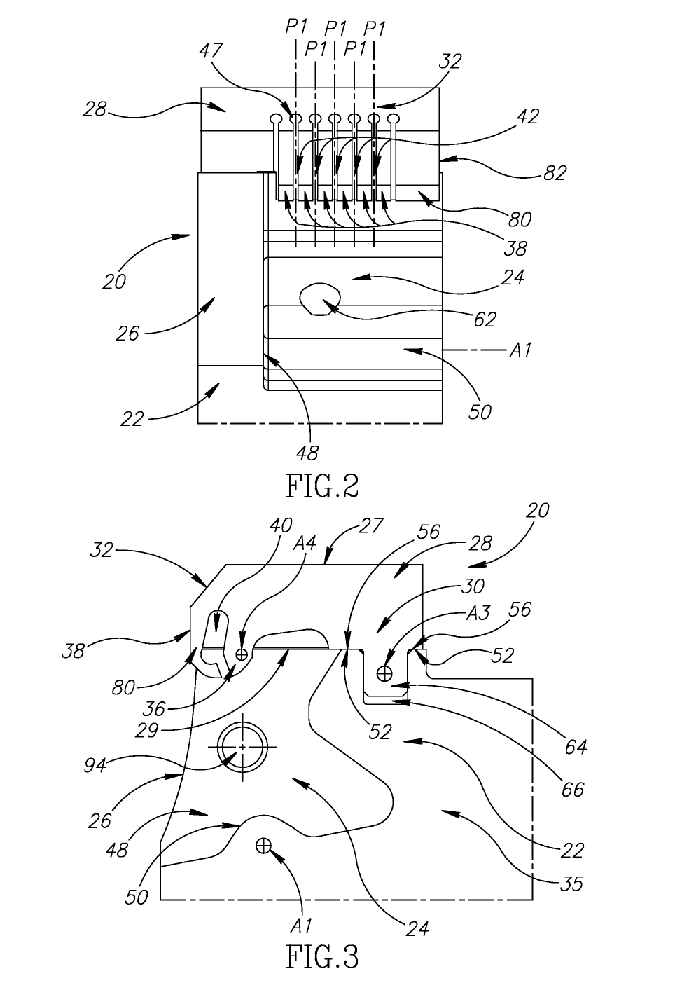

Also, according to some embodiments of the present invention, as shown in FIGS. 2 and 4, at least one clamping slot 42 separates the plurality of clamping fingers 38, and a slot plane P1 longitudinally bisects each clamping slot 42.

It should be appreciated that throughout the description and claims of the present invention, the term “bisects” is used to describe clamping slots 42 divided into two equal or nearly equal parts.

In some embodiments of the present invention, each of the at least one clamping slot 42 may exhibit mirror symmetry about its associated slot plane P1.

Also, in some embodiments of the present invention, the clamping passage 40 may be in direct communication with the at least one clamping slot 42.

As shown in FIGS. 4 and 5, the clamp 28 includes a longitudinal axis L extending in a front to back direction of the clamp 28 parallel to one of the at least one slot plane P1. The connecting portion 30 and the clamping portion 32 may be located at opposite ends of the clamp 28 along the longitudinal axis L.

In some embodiments of the present invention, as shown in FIG. 4, each of the plurality of clamping fingers 38 may have a substantially constant lateral finger width Wf perpendicular to one of the least one slot plane P1, and each of the at least one clamping slot 42 may have a substantially constant slot width Ws perpendicular to one of the least one slot plane P1, and the sum of the lateral finger widths Wf may be greater than the sum of the slot widths Ws.

Each of the plurality of clamping fingers 38 having substantially constant lateral finger widths Wf is beneficial with respect to the manufacturing efficiency of the clamp 28.

The sum of the lateral finger widths Wf being greater than the sum of the slot widths Ws advantageously maximizes the number of clamping fingers 38 which can be provided within the clamping portion 32.

It should be appreciated that throughout the description and claims of the present invention, the term “substantially constant” is used to describe lateral finger and slot widths Wf, Ws which are constant with the possible exception of base end portions 44 of the clamping fingers 38, where stress-relief recesses 47 may be located.

In some embodiments of the present invention, each of the plurality of clamping fingers 38 may be elongated in a top to bottom direction of the clamp 28 parallel to one of the at least one slot plane P1 and transverse to the longitudinal axis L.

As shown in FIG. 5, each of the plurality of clamping fingers 38 may include a base end portion 44 having a base thickness Tb parallel to one of the at least one slot plane P1, an intermediate portion 45 and a distal end portion 46. The distal end portion 46 is spaced apart from the base end portion 44 by a finger length Lf along the top to bottom direction of the clamp 28, and each finger length Lf may be greater than its associated base thickness Tb.

Also, as shown in FIG. 5, each intermediate portion 45 may be spaced apart from the clamping protrusion 36 by the clamping passage 40. Each distal end portion 46 may be spaced apart from the clamping protrusion 36 by a clamping gap G, and each finger length Lf may be greater than its associated clamping gap G.

In some embodiments of the present invention, as shown in FIGS. 1 and 2, the insert receiving pocket 24 may include a substantially planar support wall 48, and the support wall 48 may be parallel to one of the at least one slot plane P1.

It should be appreciated that throughout the description and claims of the present invention, the term “substantially planar” is used to describe a support wall 48 having at least several coplanar sub-walls (not shown), as well as a single planar support wall 48.

As shown in FIGS. 1 and 3, the insert receiving pocket 24 may include an abutment ridge 50 extending along a pivot axis A1 transverse to the support wall 48, and the clamping portion 32 may be located opposite the abutment ridge 50.

In some embodiments of the present invention, the clamping passage 40 may be elongated in the top to bottom direction of the clamp 28.

As shown in FIG. 5, the clamping passage 40 may have a passage length Lp along the top to bottom direction of the clamp 28, and the passage length Lp may be greater than each of the base thicknesses Tb.

In some embodiments of the present invention, by virtue of being elongated, each of the plurality of clamping fingers 38 may be independently resilient, having a resilience axis of rotation R1 transverse to one of the at least one slot plane P1.

It should be appreciated that throughout the description and claims of the present invention, the term “independently resilient” is used to describe a characteristic of the plurality of clamping fingers 38, where a resilient force exerted by one of the plurality of clamping fingers 38 is independent of a resilient force exerted by another of the plurality of clamping fingers 38.

Also, in some embodiments of the present invention, in contrast to the plurality of clamping fingers 38, which may be independently resilient, the clamping protrusion 36 may be rigid, and not have a resilience axis of rotation.

As shown in FIG. 5, each resilience axis of rotation R1 may intersect its associated clamping finger 38 in the vicinity of its base end portion 44.

In some embodiments of the present invention, each resilience axis of rotation R1 may be perpendicular to one of the at least one slot plane P1.

Also, in some embodiments of the present invention, the plurality of resilience axes of rotation R1 may be coaxial.

Further, in some embodiments of the present invention, as shown in FIGS. 4 and 5, the connecting portion 30 may include at least one planar stopper surface 52 and a fastening bore 54, and the at least one planar stopper surface 52 may be perpendicular to one of the at least one slot plane P1, and the fastening bore 54 may have a bore axis A2 transverse to a stopper plane P2 defined by one of the at least one planar stopper surface 52.

As shown in FIG. 3, the at least one stopper surface 52 may bear against at least one shoulder surface 56 on the tool holder body 22.

Also, as shown in FIG. 5, the bore axis A2 may be perpendicular to the stopper plane P2.

In some embodiments of the present invention, the fastening member 34 may be a fastening screw and the fastening bore 54 may be a through bore, and the fastening member 34 may extend through the fastening bore 54 and threadingly engage a threaded holder bore 62 in the tool holder body 22.

Also, in some embodiments of the present invention, the connecting portion 30 may include a male or female type mounting member 64 extending along a mounting axis A3 transverse to the at least one slot plane P1.

As shown in FIG. 5, the bore axis A2 may intersect the male or female type mounting member 64.

As shown in FIG. 4, the mounting axis A3 may be perpendicular to one of the at least one slot plane P1.

Also, in some embodiments of the present invention, the tool holder body 22 may have a female or male type receiving member 66 adjacent the insert receiving pocket 24, and the male or female type mounting member 64 may slidably engage with the female or male type receiving member 66 along the mounting axis A3.

As shown in FIGS. 4 and 5, the male or female type mounting member 64 may be a mounting ridge having two opposing side walls 70 parallel to the mounting axis A3.

According to the present invention, the clamping protrusion 36 laterally extends along a clamping axis A4 transverse to the at least one slot plane P1, and the at least one slot plane P1 intersects the clamping protrusion 36.

As shown in FIG. 4, the clamping axis A4 may be perpendicular to one of the at least one slot plane P1.

In some embodiments of the present invention, the clamping protrusion 36 may have a uniform cross-section along the clamping axis A4.

Also, in some embodiments of the present invention, the clamping protrusion 36 may have a convex primary clamping surface 72 containing a first imaginary straight contact line L1 along which the primary clamping surface 72 may simultaneously contact a plurality of cutting inserts, each of the plurality of clamping fingers 38 may have a convex secondary clamping surface 74 containing a second imaginary straight contact line L2 along which the secondary clamping surface 74 may contact a single cutting insert, and the first and second imaginary straight contact lines L1, L2 may be parallel to the clamping axis A4.

Further, in some embodiments of the present invention, the plurality of second imaginary straight contact lines L2 may be collinear.

It should be appreciated that throughout the description and claims of the present invention, the plurality of second imaginary straight contact lines L2 may be collinear, within manufacturing tolerances, when the plurality of clamping fingers 38 are in a non-operative state.

As shown in FIG. 4, the at least one slot plane P1 may intersect the first imaginary straight contact line L1.

As shown in FIG. 5, third and fourth imaginary straight lines L3, L4 may extend perpendicularly away from the primary and secondary clamping surfaces 72, 74, respectively, and the third and fourth imaginary straight lines L3, L4 may diverge in a direction away from the clamping portion 32.

In some embodiments of the present invention, the third and fourth imaginary straight lines L3, L4 may be perpendicular to their associated first and second imaginary straight contact lines L1, L2, respectively.

Also, in some embodiments of the present invention, the plurality of clamping fingers 38 may be separated by a plurality of clamping slots 42.

As shown in FIGS. 2 and 4, the plurality of slot planes P1 associated with the plurality of clamping slots 42 may be parallel to each other.

The plurality of slot planes P1 being parallel is beneficial with respect to the manufacturing efficiency of the clamp 28.

Thus, as shown in FIGS. 4 and 5, the multi-insert tool clamp 28 has a longitudinal axis L defining a front to back direction and comprising: a tool holder connecting portion 30 and an insert clamping portion 32 spaced apart therefrom. The insert clamping portion 32 comprises a clamping protrusion 36 extending along a clamping axis A4 which is transverse to the longitudinal axis L, the clamping protrusion 36 having a first insert clamping surface 72. The insert clamping portion 32 also comprises a row of clamping fingers 38 spaced apart from one another in the direction of the clamping axis A4, each clamping finger 38 having a base end portion 44 via which the clamping finger 38 is connected to the clamping protrusion 36, an intermediate portion 45 and a distal end portion 46, the distal end portion 46 provided with a second insert clamping surface 74. A clamping passage 40 separates the intermediate portions 45 of the clamping fingers 38 from the clamping protrusion 36.

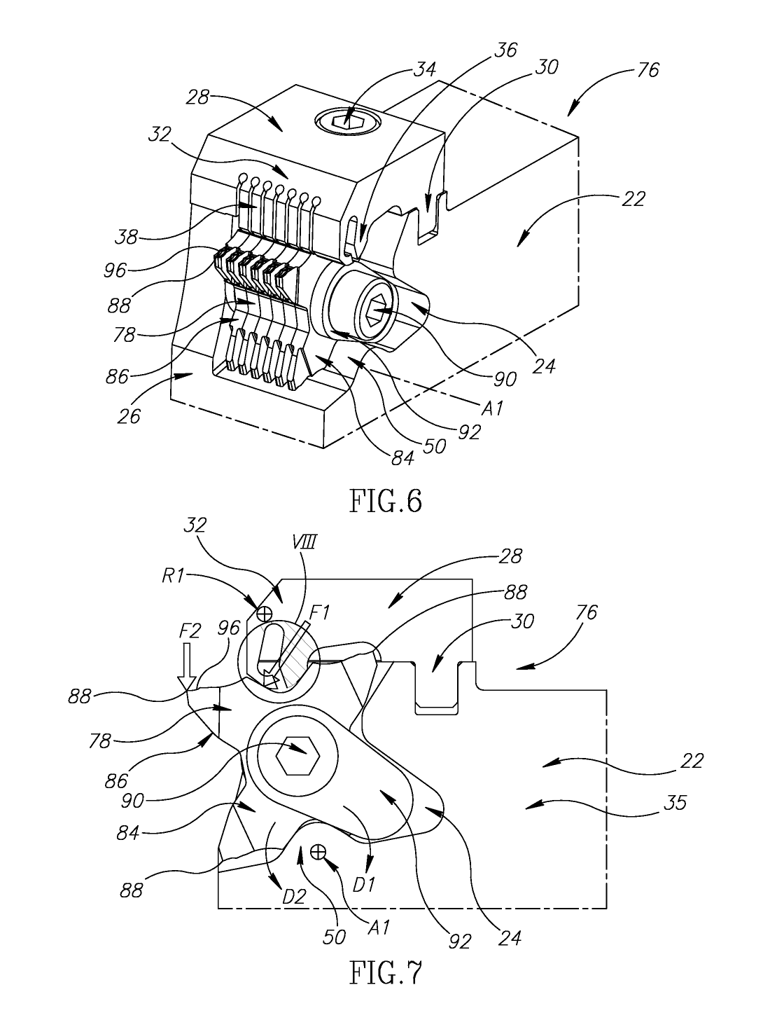

Attention is now drawn to FIGS. 6 and 7, showing a cutting tool 76 with a plurality of cutting inserts 78 removably secured in the single insert receiving pocket 24 of the tool holder body 22.

In some embodiments of the present invention, the total number of cutting inserts 78 may be equal to the total number of clamping fingers 38.

Also, in some embodiments of the present invention, the clamping protrusion 36 may make simultaneous clamping contact with each of the plurality of cutting inserts 78, and each of the plurality of clamping fingers 38 may make clamping contact with only one of the plurality of cutting inserts 78.

It should be appreciated that in some embodiments of the present invention, the clamping portion 32 may also include a non-clamping finger 80, which does not make clamping contact with any of the plurality of cutting inserts 78. The non-clamping finger 80 may be located at a lateral end 82 of the clamping portion 32, to protect its adjacent clamping finger 38 from cutting chip abrasions and wearing associated with metal machining operations.

In some embodiments of the present invention, the plurality of cutting inserts 78 may be identical to each other.

Also, in some embodiments of the present invention, each of the plurality of cutting inserts 78 may have two opposing end surfaces 84 and a peripheral side surface 86 extending therebetween, and at least one cutting edge 88 extending between the two opposing end surfaces 84.

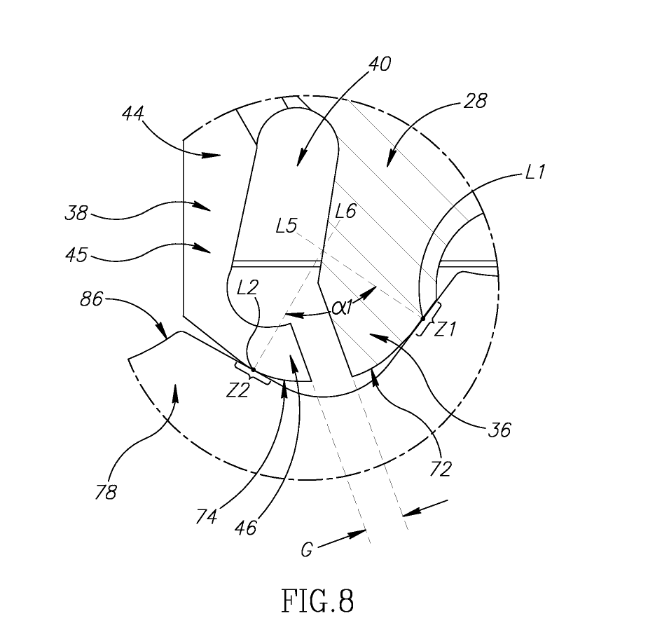

As shown in FIG. 8, the clamping portion 32 may make clamping contact with each peripheral side surface 86 at only two spaced apart contact zones Z1, Z2, a first of the two contact zones Z1 coinciding with the convex primary clamping surface 72 of the clamping protrusion 36 and a second of the two contact zones Z2 coinciding with the convex secondary clamping surface 74 of one of the plurality of clamping fingers 38.

In some embodiments of the present invention, each second contact zone Z2 may span the width of its associated peripheral side surface 86.

Also, in some embodiments of the present invention, the first contact zones Z1 coincide with the first imaginary straight contact line L1 on the primary clamping surface 72, and the second contact zones Z2 coincide with their associated second imaginary straight contact lines L2 on the secondary clamping surfaces 74.

As shown in FIG. 8, fifth and sixth imaginary straight lines L5, L6 extending perpendicularly away from the peripheral side surface 86 at each of the first and second contact zones Z1, Z2, respectively, may form an external contact angle αl, and the external contact angle α1 may have a value of between 60° and 140°.

In some embodiments of the present invention, the fifth and sixth imaginary straight lines L5, L6 may be collinear with the third and fourth imaginary straight lines L3, L4, respectively.

It should be appreciated that throughout the description and claims of the present invention, the term “external” is used to describe the contact angle α1 formed between the fifth and sixth imaginary straight lines L5, L6, when measured at their intersection external to the associated cutting insert 78.

In some embodiments of the present invention, the plurality of cutting inserts 78 may be removably secured in the insert receiving pocket 24 by means of the clamp 28 and the fastening member 34 operatively connected thereto. The clamping gaps G between the distal end portion 46 of each clamping finger 38 and the clamping protrusion 36 may decrease in response to the fastening member 34 being tightened and increase in response to the fastening member 34 being untightened.

The clamping gaps G may decrease during tightening of the fastening member 34, due to each clamping finger 38 being resiliently deflected along the peripheral side surface 86 of its associated cutting insert 78 towards the clamping protrusion 36.

In some embodiments of the present invention, the tightening of the fastening member 34 may be completed when the at least one stopper surface 52 of the connecting portion 30 bears against the at least one shoulder surface 56 of the tool holder body 22.

The clamping gaps G may increase during untightening of the fastening member 34 until the clamping portion 32 no longer makes clamping contact with the peripheral side surfaces 86 of the plurality of cutting inserts 78.

In some embodiments of the present invention, one of the two end surfaces 84 of one of the plurality of cutting inserts 78 may be in contact with the substantially planar support wall 48 of the insert receiving pocket 24.

Also, in some embodiments of the present invention, at least one of the two end surfaces 84 of each of the plurality of cutting inserts 78 may be in contact with one of the two end surfaces 84 of another cutting insert 78.

Further, in some embodiments of the present invention, the plurality of cutting inserts 78 may be laterally locked in a ‘side-by side’ arrangement against the support wall 48 by means of a locking screw 90 and a locking plate 92. The locking screw 90 may extend through bores associated with the locking plate 92 and the plurality of cutting inserts 78, respectively, and threadingly engage a threaded wall bore 94 in the support wall 48.

As shown in FIGS. 6 and 7, each of the plurality of cutting inserts 78 may be indexable, having a plurality of cutting edges 88.

In some embodiments of the present invention, the abutment ridge 50, which extends along the pivot axis A1 transverse to the support wall 48, may make abutting contact with each peripheral side surface 86.

As shown in FIG. 2, the pivot axis A1 may be perpendicular to the support wall 48.

In some embodiments of the present invention, as shown in FIG. 7, a rake surface 96, associated with each operative cutting edge 88, may face in a first direction D1 about the pivot axis A1, and a clamping force F1, applied to each second contact zone Z2 by its associated clamping finger 32, may be directed in an opposite second direction D2 about the pivot axis A1.

The application of clamping forces F1, independently, to each second contact zone Z2, ensures that each cutting insert 78 suitably pivots about the pivot axis A1, until the clamping protrusion 36 makes clamping contact with each first contact zone Z1, and each cutting insert 78 reaches its operative orientation in the insert receiving pocket 24.

The application of independent clamping forces F1 advantageously accounts for and counteracts the manufacturing tolerances typically associated with the plurality of cutting inserts 78 to enable accurate and repeatable orientation of each cutting insert 78 within the insert receiving pocket 24.

During machining operations, the plurality of cutting inserts 78 are maintained in their operative orientations in the insert receiving pocket 24, due to cutting forces F2 acting on the operative cutting edges 88 in the second direction D2 about the pivot axis A1.

Although the present invention has been described to a certain degree of particularity, it should be understood that various alterations and modifications could be made without departing from the spirit or scope of the invention as hereinafter claimed.

What is claimed is:

1. A multi-insert tool clamp (28) for removably securing a plurality of cutting inserts (78) in a tool holder body (22), the clamp (28) comprising a tool holder connecting portion (30) and an insert clamping portion (32) spaced apart therefrom,
the insert clamping portion (32) including a clamping protrusion (36) and a plurality of clamping fingers (38),
a clamping passage (40) separates the plurality of clamping fingers (38) from the clamping protrusion (36),
at least one clamping slot (42) separates the plurality of clamping fingers (38), and
a slot plane (P1) longitudinally bisects each clamping slot (42),
wherein:
the clamping protrusion (36) laterally extends along a clamping axis (A4) transverse to the at least one slot plane (P1), and the at least one slot plane (P1) intersects the clamping protrusion (36).

2. The clamp (28) according to claim 1, wherein the clamp (28) has unitary one-piece construction.

3. The clamp (28) according to claim 1, wherein each of the at least one clamping slot (42) exhibits mirror symmetry about its associated slot plane (P1).

4. The clamp (28) according to claim 1, wherein a longitudinal axis (L) extends in a front to back direction of the clamp (28) parallel to one of the at least one slot plane (P1), and
wherein the connecting portion (30) and the clamping portion (32) are located at opposite ends of the clamp (28) along the longitudinal axis (L).

5. The clamp (28) according to claim 1, wherein the clamping protrusion (36) is located between the connecting portion (30) and the plurality of clamping fingers (38).

6. The clamp (28) according to claim 1, wherein the clamping passage (40) is in direct communication with the at least one clamping slot (42).

7. The clamp (28) according to claim 1, wherein the clamping axis (A4) is perpendicular to one of the at least one slot plane (P1).

8. The clamp (28) according to claim 1, wherein the plurality of clamping fingers (38) are identical to each other.

9. The clamp (28) according to claim 1, wherein each of the plurality of clamping fingers (38) has a constant lateral finger width (Wf) perpendicular to one of the least one slot plane (P1), and each of the at least one clamping slot (42) has a constant slot width (Ws) perpendicular to one of the least one slot plane (P1), and
wherein the sum of the lateral finger widths (Wf) is greater than the sum of the slot widths (Ws).

10. The clamp (28) according to claim 4, wherein each of the plurality of clamping fingers (38) is elongated in a top to bottom direction of the clamp (28) parallel to one of the at least one slot plane (P1) and transverse to the longitudinal axis (L).

11. The clamp (28) according to claim 10, wherein each of the plurality of clamping fingers (38) includes a base end portion (44) having a base thickness (Tb) parallel to one of the at least one slot plane (P1), and a distal end portion (46) spaced apart from the base end portion (44) by a finger length (Lf) along the top to bottom direction of the clamp (28), and
wherein each finger length (Lf) is greater than its associated base thickness (Tb).

12. The clamp (28) according to claim 11, wherein the clamping passage (40) is elongated in the top to bottom direction of the clamp (28).

13. The clamp (28) according to claim 12, wherein the clamping passage (40) has a passage length (Lp) along the top to bottom direction of the clamp (28), and
wherein the passage length (Lp) is greater than each of the base thicknesses (Tb).

14. The clamp (28) according to claim 11, wherein each distal end portion (46) is spaced apart from the clamping protrusion (36) by a clamping gap (G), and
wherein each finger length (Lf) is greater than its associated clamping gap (G).

15. The clamp (28) according to claim 1, wherein each of the plurality of clamping fingers (38) is independently resilient, having a resilience axis of rotation (R1) transverse to one of the at least one slot plane (P1).

16. The clamp (28) according to claim 15, wherein each resilience axis of rotation (R1) is perpendicular to one of the at least one slot plane (P1).

17. The clamp (28) according to claim 15, wherein each of the plurality of clamping fingers (38) includes a base end portion (44), and
wherein each resilience axis of rotation (R1) intersects its associated clamping finger (38) in the vicinity of its base end portion (44).

18. The clamp (28) according to claim 15, wherein the plurality of resilience axes of rotation (R1) are coaxial.

19. The clamp (28) according to claim 1, wherein the plurality of clamping fingers (38) are separated by a plurality of clamping slots (42).

20. The clamp (28) according to claim 19, wherein the plurality of slot planes (P1) associated with the plurality of clamping slots (42) are parallel to each other.

21. The clamp (28) according to claim 1, wherein the clamping protrusion (36) has a convex primary clamping surface (72) containing a first imaginary straight contact line (L1),
wherein each of the plurality of clamping fingers (38) has a convex secondary clamping surface (74) containing a second imaginary straight contact line (L2), and
wherein the first and second imaginary straight contact lines (L1, L2) are parallel to the clamping axis (A4).

22. The clamp (28) according to claim 21, wherein the plurality of second imaginary straight contact lines (L2) are collinear.

23. The clamp (28) according to claim 21, wherein third and fourth imaginary straight line (L3, L4) extend perpendicularly away from the primary and secondary clamping surfaces (72, 74), respectively, and
wherein the third and fourth imaginary straight line (L3, L4) diverge in a direction away from the clamping portion (32).

24. The clamp (28) according to claim 21, wherein the at least one slot plane (P1) intersects the first imaginary straight line (L1).

25. The clamp (28) according to claim 1, wherein the clamping protrusion (36) has a uniform cross-section along the clamping axis (A4).

26. A tool holder assembly (20) for removably securing a plurality of cutting inserts (78), comprising a tool holder body (22) with a single insert receiving pocket (24) formed in a front end portion (26) thereof, and a single clamp (28) in accordance with claim 1 connected to the tool holder body (22).

27. The tool holder assembly (20) according to claim 26, wherein the connecting portion (30) of the clamp (28) is removably fastened to the tool holder body (22) adjacent the insert receiving pocket (24) by means of a fastening member (34).

28. The tool holder assembly (20) according to claim 26, wherein the tool holder body (22) has a shank portion (35) extending rearwardly from the front end portion (26), and
wherein the connecting portion (30) of the clamp (28) is at least partially located rearward of the insert receiving pocket (24).

29. The tool holder assembly (20) according to claim 26, wherein the insert receiving pocket (24) includes a substantially planar support wall (48), and
wherein the support wall (48) is parallel to one of the at least one slot plane (P1).

30. The tool holder assembly (20) according to claim 29, wherein the insert receiving pocket (24) includes an abutment ridge (50) extending along a pivot axis (A1) transverse to the support wall (48), and
wherein the clamping portion (32) of the clamp (28) is located opposite the abutment ridge (50).

31. The tool holder assembly (20) according to claim 27, wherein the connecting portion (30) includes at least one planar stopper surface (52) and a fastening bore (54), and
wherein the at least one planar stopper surface (52) is perpendicular to one of the at least one slot plane (P1), and
wherein the fastening bore (54) has a bore axis (A2) transverse to a stopper plane (P2) defined by one of the at least one planar stopper surface (52).

32. The tool holder assembly (20) according to claim 31, wherein the at least one stopper surface (52) bears against at least one shoulder surface (56) on the tool holder body (22).

33. The tool holder assembly (20) according to claim 31, wherein the bore axis (A2) is perpendicular to the stopper plane (P2).

34. The tool holder assembly (20) according to claim 31, wherein the fastening member (34) is a fastening screw and the fastening bore (54) is a through bore, and
wherein the fastening screw extends through the through bore and threadingly engages a holder bore (62) in the tool holder body (22).

35. The tool holder assembly (20) according to claim 31, wherein the connecting portion (30) includes a male or female type mounting member (64) extending along a mounting axis (A3) transverse to the at least one slot plane (P1).

36. The tool holder assembly (20) according to claim 35, wherein the bore axis (A2) intersects the male or female type mounting member (64).

37. The tool holder assembly (20) according to claim 35, wherein the mounting axis (A3) is perpendicular to one of the at least one slot plane (P1).

38. The tool holder assembly (20) according to claim 35, wherein the male or female type mounting member (64) is a mounting ridge having two opposing side walls (70) parallel to the mounting axis (A3).

39. The tool holder assembly (20) according to claim 35, wherein the tool holder body (22) has a female or male type receiving member (66) adjacent the insert receiving pocket (24), and
wherein the male or female type mounting member (64) slidably engages with the female or male type receiving member (66) along the mounting axis (A3).

40. A cutting tool (76) comprising the tool holder assembly (20) in accordance with claim 26, and a plurality of cutting inserts (78) removably secured in the single insert receiving pocket (24).

41. The cutting tool (76) according to claim 40, wherein the total number of cutting inserts (78) is equal to the total number of clamping fingers (38).

42. The cutting tool (76) according to claim 40, wherein the plurality of cutting inserts (78) are identical to each other.

43. The cutting tool (76) according to claim 40, wherein the clamping protrusion (36) makes simultaneous clamping contact with each of the plurality of cutting inserts (78), and
wherein each of the plurality of clamping fingers (38) makes clamping contact with only one of the plurality of cutting inserts (78).

44. The cutting tool (76) according to claim 40, wherein the plurality of cutting inserts (78) are removably secured in the insert receiving pocket (24) by means of the clamp (28) and a fastening member (34) operatively connected thereto,
wherein a distal end portion (46) of each of the plurality of clamping fingers (38) is spaced apart from the clamping protrusion (36) by a clamping gap (G), and
wherein each clamping gap (G) decreases in response to the fastening member (34) being tightened and increases in response to the fastening member (34) being untightened.

45. The cutting tool (76) according to claim 40, wherein each of the plurality of cutting inserts (78) has two opposing end surfaces (84) and a peripheral side surface (86) extending therebetween,
wherein at least one cutting edge (88) extends between the two opposing end surfaces (84),
wherein the clamping portion (32) makes clamping contact with each peripheral side surface (86) at only two spaced apart contact zones (Z1, Z2), and
wherein a first of the two contact zones (Z1) coincides with a convex primary clamping surface (72) of the clamping protrusion (36) and a second of the two contact zones (Z2) coincides with a convex secondary clamping surface (74) of one of the plurality of clamping fingers (38).

46. The cutting tool (76) according to claim 45, wherein at least one of the two end surfaces (84) of each of the plurality of cutting inserts (78) is in contact with one of the two end surfaces (84) of another cutting insert (78).

47. The cutting tool (76) according to claim 45, wherein each of the plurality of cutting inserts (78) is indexable, having a plurality of cutting edges (88).

48. The cutting tool (76) according to claim 45, wherein fifth and sixth imaginary straight lines (L5, L6) extending perpendicularly away from the peripheral side surface (86) at each of the first and second contact zones (Z1, Z2), respectively, form an external contact angle (α1), and
wherein the external contact angle (al) has a value of between 60° and 140°.

49. The cutting tool (76) according to claim 45, wherein the insert receiving pocket (24) includes a substantially planar support wall (48), and
wherein one of the two end surfaces (84) of one of the plurality of cutting inserts (78) is in contact with the support wall (48).

50. The cutting tool (76) according to claim 49, wherein the insert receiving pocket (24) includes an abutment ridge (50) extending along a pivot axis (A1) transverse to the support wall (48), and
wherein a rake surface (96), associated with each operative cutting edge (88), faces in a first direction (D1) about the pivot axis (A1), and a clamping force (F1), applied to each second contact zone (Z2) by its associated clamping finger (38), is directed in an opposite second direction (D2) about the pivot axis (A1).

51. The cutting tool (76) according to claim 50, wherein the pivot axis (A1) is perpendicular to the support wall (48).

52. The cutting tool (76) according to claim 50, wherein the abutment ridge (50) makes abutting contact with each peripheral side surface (86).

53. A multi-insert tool clamp (28) having a longitudinal axis (L) defining a front to back direction, comprising:
a tool holder connecting portion (30) and an insert clamping portion (32) spaced apart therefrom, the insert clamping portion (32) comprising:
a clamping protrusion (36) extending along a clamping axis (A4) which is transverse to the longitudinal axis (L), the clamping protrusion (36) having a first insert clamping surface (72);
a row of clamping fingers (38) spaced apart from one another in the direction of the clamping axis (A4), each clamping finger (38) having a base end portion (44) via which the clamping finger (38) is connected to the clamping protrusion (36), an intermediate portion (45) and a distal end portion (46), the distal end portion (46) provided with a second insert clamping surface (74); and
a clamping passage (40) separating the intermediate portions (45) of the clamping fingers (38) from the clamping protrusion (36).
